(19) United States
(12) Patent Application Publication
(10) Pub. No.: US 2026/0064084 A1
(43) Pub. Date: Mar. 5, 2026

(54) SWITCH DEVICE AND TIMEPIECE

(71) Applicant: CASIO COMPUTER CO., LTD., Tokyo (JP)

(72) Inventors: Hiroki IGI, Tokyo (JP); Masaki MIYATA, Tokyo (JP)

(21) Appl. No.: 19/310,753

(22) Filed: Aug. 26, 2025

(30) Foreign Application Priority Data
Aug. 28, 2024 (JP) 2024-146241

(51) Int. Cl. G04G 21/08

(52) U.S. Cl. CPC G04G 21/08

(57) ABSTRACT

A switch device including a case provided with a through hole, an operation member having a shaft section which is inserted into the through hole of the case and a head section provided on an outer end portion of the shaft section, and a buffering member which is arranged in the head section of the operation member, in which the buffering member includes a cylindrical main body section, a plurality of first projection sections which projects toward the head section side from one surface of the main body section, and a plurality of second projection sections which projects toward the case side from an other surface of the main body section located on a side opposite to the head section side, and the first projection sections and the second projection sections are arranged at positions not overlapping with each other in an axial direction of the operation member.

### CROSS-REFERENCE TO RELATED APPLICATION

This application is based upon and claims the benefit of priority from the prior Japanese Patent Application No. 2024-146241, filed August 28, 2024, the entire contents of which are incorporated herein by reference.

### BACKGROUND

### 1. Technical Field

The present disclosure relates to a switch device that is used for electronic devices such as wristwatches, and a timepiece equipped with the switch device.

### 2. Description of the Related Art

For example, Japanese Utility-Model Application Laid-Open (Kokai) Publication No. 52-52979 discloses the structure of a wristwatch winder section in which a pipe (winding core pipe) is attached to a through hole in a wristwatch case (body), and an operation member (a winder core and a winder body) is attached to the pipe in a manner to be rotatable and slidable in an axial direction.

This wristwatch winder section has a locking mechanism where the operation member is locked in the pipe so that, when subjected to an external impact, the operation member is prevented from being pressed into the wristwatch case and thereby does not damage a timepiece module in the wristwatch case.

### SUMMARY

An embodiment of the present disclosure is a switch device comprising: a case provided with a through hole; an operation member having a shaft section which is inserted into the through hole of the case and a head section provided on an outer end portion of the shaft section; and a buffering member which is arranged in the head section of the operation member, wherein the buffering member includes a cylindrical main body section, a plurality of first projection sections which projects toward the head section side from one surface of the main body section, and a plurality of second projection sections which projects toward the case side from an other surface of the main body section located on a side opposite to the head section side, and wherein the plurality of first projection sections and the plurality of second projection sections are arranged at positions not overlapping with each other in an axial direction of the operation member when viewed from the head section side of the operation member.

According to the present disclosure, external impacts are buffered.

The above and further objects and novel features of the present disclosure will more fully appear from the following detailed description when the same is read in conjunction with the accompanying drawings. It is to be expressly understood, however, that the drawings are for the purpose of illustration only and are not intended as a definition of the limits of the disclosure.

### BRIEF DESCRIPTION OF THE DRAWINGS

FIG. 1 is an enlarged front view showing an embodiment in which the present disclosure has been applied in a wristwatch;

FIG. 2 is an enlarged cross-sectional view showing a main portion of the wristwatch taken along the A-A arrow view in FIG. 1;

FIG. 3 is an enlarged cross-sectional view showing the main portion of the wristwatch, in which the locking of an operation member by a locking mechanism in a switch device shown in FIG. 2 has been released;

FIG. 4 is an exploded perspective view of the switch device of FIG. 2 when viewed from the outer side of the wristwatch case;

FIG. 5 is an exploded perspective view of the switch device of FIG. 2 when viewed from the inner side of the wristwatch case; and

FIG. 6 is an enlarged perspective view showing a buffering member in the switch device shown in FIG. 4.

### DETAILED DESCRIPTION OF THE PREFERRED EMBODIMENT

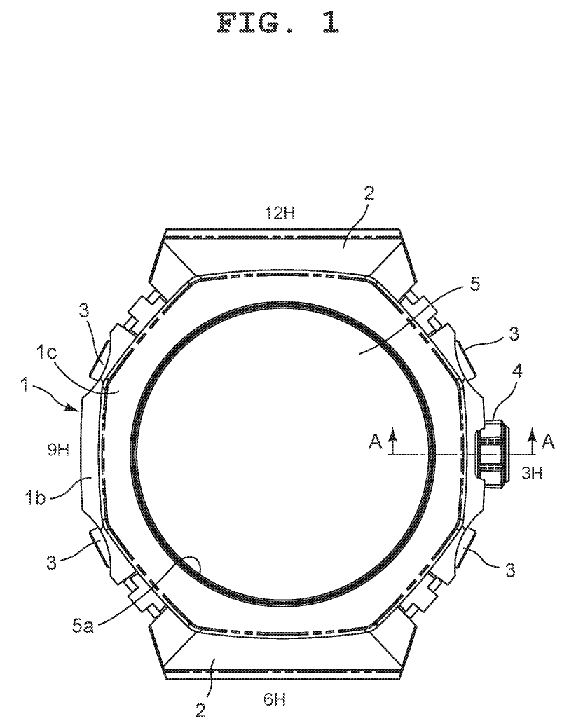

An embodiment where the present disclosure has been applied in a wristwatch will hereinafter be descried with reference to FIG. 1 to FIG. 6.

This wristwatch has a wristwatch case 1, as shown in FIG. 1. On the twelve o’clock side and six o’clock side of the wristwatch case 1, band attachment sections 2 where a watch band (not shown in the drawings) is attached are provided.

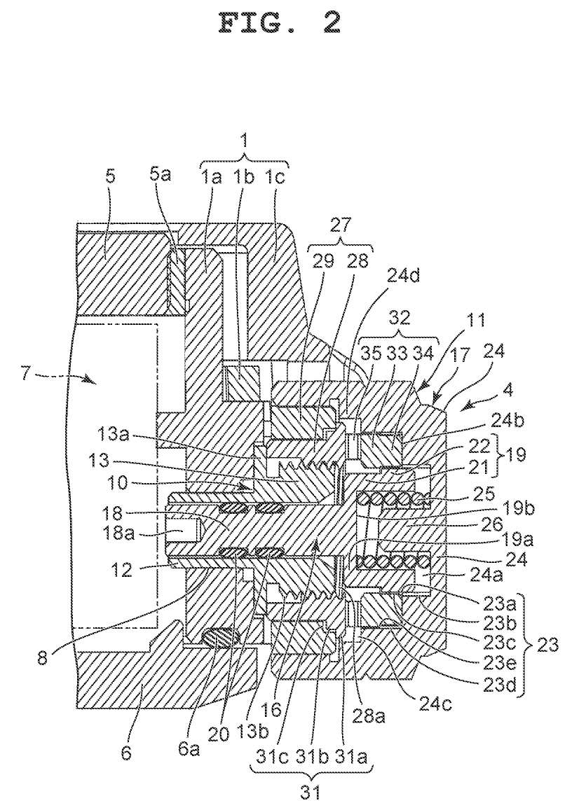

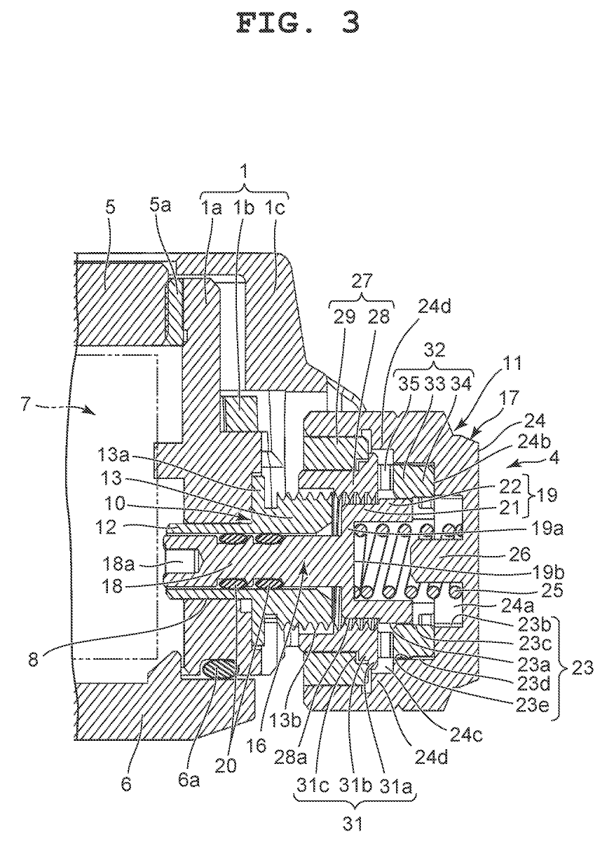

On the two o’clock side, four o’clock side, eight o’clock side, and ten o’clock side of the wristwatch case 1, push-button switches 3 are provided, respectively, as shown in FIG. 1. Also, on the three o’clock side of the wristwatch case 1, a switch device 4 is provided. Moreover, to the upper opening of the wristwatch case 1, a watch glass 5 is attached via a glass packing 5a, as shown in FIG. 2 and FIG. 3. Furthermore, to the lower part of this wristwatch case 1, a back cover 6 is attached by via a waterproof packing 6a.

Inside this wristwatch case 1, a timepiece module 7 is provided, as shown in FIGS. 2 and 3. Although not shown in the drawings, the timepiece module 7 includes various types of components required to actualize timepiece functions, such as a timepiece movement which moves pointers to indicate the time, a flat-type display device which electro-optically displays information such as a time of day, a date, and a day of the week, and a circuit section which drives and controls these components.

This wristwatch case 1 includes a case main body 1a, a first exterior member 1b which is arranged on the outer circumferential surface of the case main body 1a, and a second exterior member 1c which is arranged on the outer circumferential surface of the upper part of the case main body 1a and positioned over the first exterior member 1b, as shown in FIGS. 2 and 3. Here, the case main body 1a is made of metal or a highly rigid synthetic resin, and the first exterior member 1b is made of an elastic synthetic resin such as urethane resin. The second exterior member 1c is made of metal or synthetic resin.

The switch device 4 on the three o’clock side of the wristwatch case 1 is a switch for performing time correction and function setting or selection such as mode switching, as shown in FIGS. 1 and 3. This switch device 4 includes a cylindrical member 10 which is attached to a through hole 8 formed in the case main body 1a of the wristwatch case 1, an operation member 11 which is attached to the cylindrical member 10 in a manner to be slidable and rotatable, and a locking mechanism 27 which locks the operation member 11 to the cylindrical member 10.

For example, in the case of the switch device of the Japanese Utility-Model Application Laid-Open (Kokai) Publication No. 52-52979 described above, there is a problem in that, when the operation member is subjected to an external impact while being locked in the pipe by the locking mechanism, this impact is not buffered, whereby the male screw section of the pipe and the female screw section of the head part of the operation member engaged with each other are damaged.

An object of the present disclosure is to provide a switch device that buffers external impacts, and a timepiece equipped with this switch device.

In the present embodiment, the cylindrical member 10 is made of a highly rigid metal such as stainless steel, and has a substantially pipe shape, as shown in FIGS. 2 and 3. This cylindrical member 10 includes a small-diameter cylindrical section 12 which is inserted into the through hole 8 in the case main body 1a of the wristwatch case 1, and a large-diameter cylindrical section 13 which is arranged protruding from the case main body 1a. The small-diameter cylindrical section 12 is formed such that its outer diameter is substantially equal to the inner diameter of the through hole 8 of the case main body 1a, and its inner diameter is slightly shorter than the inner diameter of the through hole 8. As a result, this small-diameter cylindrical section 12 has a thin pipe shape.

Also, this small-diameter cylindrical section 12 is formed such that its axial length is slightly longer than the axial length of the through hole 8, as shown in FIGS. 2 and 3. As a result, this small-diameter cylindrical section 12 is structured such that, when the large-diameter cylindrical section 13 comes in contact with and is arranged on the outer surface of the case main body 1a of the wristwatch case 1, an inner end portion of the small-diameter cylindrical section 12 protrudes inside the case main body 1a.

The outer circumferential portion of the inner end portion of the small-diameter cylindrical section 12 protruding inside the wristwatch case 1 is entirely fixed to the rim of the inner end portion of the through hole 8 in the case main body 1a by welding such as laser welding or brazing and Loctite (registered trademark), as shown in FIGS. 2 and 3. As a result, by this welding such as laser welding or brazing and Loctite, waterproofing between the inner circumferential surface of the through hole 8 in the case main body 1a of the wristwatch case 1 and the outer circumferential surface of the small-diameter cylindrical section 12 of the cylindrical member 10 is achieved.

The large-diameter cylindrical section 13 is formed such that its outer diameter is longer than the inner diameter of the through hole 8 of the case main body 1a of the wristwatch case 1, and shorter than the vertical length (height) of the wristwatch case 1, as shown in FIGS. 2 and 3. More specifically, the large-diameter cylindrical section 13 is formed such that its outer diameter is, for example, about three times longer than the inner diameter of the through hole 8 and about half the vertical length of the wristwatch case 1. Also, the large-diameter cylindrical section 13 is formed such that its inner diameter is equal to the inner diameter of the small-diameter cylindrical section 12.

As a result, the large-diameter cylindrical section 13 has a pipe shape whose length (thickness) between the inner diameter and the outer diameter is sufficiently longer (thicker) than the length (thickness) between the inner diameter and outer diameter of the small-diameter cylindrical section 12, as shown in FIGS. 2 and 3. Also, the large-diameter cylindrical section 13 is formed such that its axial length is, for example, substantially equal to the axial length of the through hole 8 in the case main body 1a of the wristwatch case 1.

Moreover, the large-diameter cylindrical section 13 is formed such that its outer diameter on the outer side of the wristwatch case 1 is one size smaller than its outer diameter on the inner side of the wristwatch case 1, as shown in FIGS. 2 and 3. More specifically, the large-diameter cylindrical section 13 has a contact cylindrical section 13a which is an inner contact section on the wristwatch case 1 side and one size larger, and an outer cylindrical section on the opposite side which is one size smaller and whose axial length is sufficiently longer than the axial length of the contact cylindrical section 13a on the inner side. On the outer circumferential surface of the outer cylindrical section of the large-diameter cylindrical section 13 which is one size smaller, a male screw section 13b of the locking mechanism 27 which is described later is formed.

On the other hand, the operation member 11 which is attached to the cylindrical member 10 includes an operation shaft section 16 which is slidably and rotatably arranged in the cylindrical member 10 and protrudes outside the cylindrical member 10, and an operation head section 17 which is attached to an outer end portion of the operation shaft section 16 protruding from the cylindrical member 10 in a manner to be slidable in an axial direction and covers the outer end portion of the operation shaft section 16 and the large-diameter cylindrical section 13 of the cylindrical member 10, as shown in FIGS. 2 to 5. The operation shaft section 16 is made of a metal such as stainless steel or titanium alloy or a hard synthetic resin.

The operation shaft section 16 includes a shaft body section 18 which is inserted into the cylindrical member 10, and a shaft operation section 19 which is provided on the outer end of the shaft body section 18 and protrudes outside the cylindrical member 10, as shown in FIGS. 2 to 5. The shaft body section 18 is formed such that its outer diameter is substantially equal to the inner diameter of the cylindrical member 10, and its axial length is slightly longer than that of the cylindrical member 10. Note that the axial length of the shaft body section 18 may be shorter than that of the cylindrical member 10.

As a result, the shaft body section 18 is structured to be rotatable and slidable in the cylindrical member 10 when the inner end of the shaft body section 18 is positioned on the inner end side of the cylindrical member 10 and the outer end of the shaft body section 18 is positioned slightly away from the outer end of the cylindrical member 10, as shown in FIGS. 2 to 5. Also, in outer circumferential portions of the shaft body section 18, a plurality of waterproof rings 20 is provided, which is structured to achieve waterproofing between the outer circumferential surface of the shaft body section 18 and the inner circumferential surface of the cylindrical member 10.

The shaft operation section 19 is integrally provided with the outer end of the shaft body section 18 positioned at the outer end of the cylindrical member 10, and structured to slide and rotate the shaft body section 18, as shown in FIGS. 2 to 5. More specifically, the shaft operation section 19 is formed in a substantially cylindrical shape, and has a bottom section 19a formed on the outer end of the shaft body section 18. In the shaft operation section 19, a hollow recess section 19b having a circular cross shape is formed in an axial direction of the operation member 11.

Also, this shaft operation section 19 includes an inner cylindrical section 21 whose outer circumferential part has a small diameter and an outer cylindrical section 22 whose outer circumferential part has a large diameter, as shown in FIGS. 2 and 3. The small-diameter inner cylindrical section 21 is formed such that its outer diameter is slightly shorter than the outer diameter of the male screw section 13b formed on the outer circumference surface of the large-diameter cylindrical section 13 of the cylindrical member 10, that is, slightly shorter than the inner diameter of a female screw section 28a in the locking mechanism 27 which is described later.

Also, the small-diameter inner cylindrical section 21 is structured such that its inner end portion, that is, the bottom section 19a of the shaft operation section 19 comes close to the outer end of the large-diameter cylindrical section 13 of the cylindrical member 10, that is, the outer end surface of the male screw section 13b while being separable therefrom, as shown in FIGS. 2 and 3. That is, the small-diameter inner cylindrical section 21 is structured such that its inner end portion, that is, the bottom section 19a of the shaft operation section 19 does not come in contact with the outer end surface of the male screw section 13b of the large-diameter cylindrical section 13. When the locking of the operation head section 17 with respect to the large-diameter cylindrical section 13 is released, the female screw section 28a of a locking member 28 is moved to and arranged around the outer circumference of the small-diameter inner cylindrical section 21, as shown in FIG. 3.

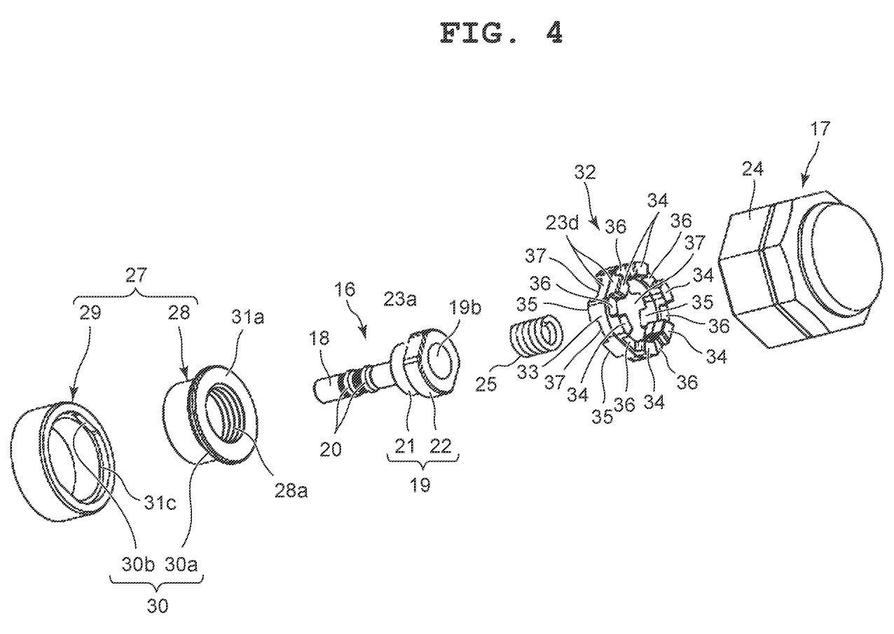

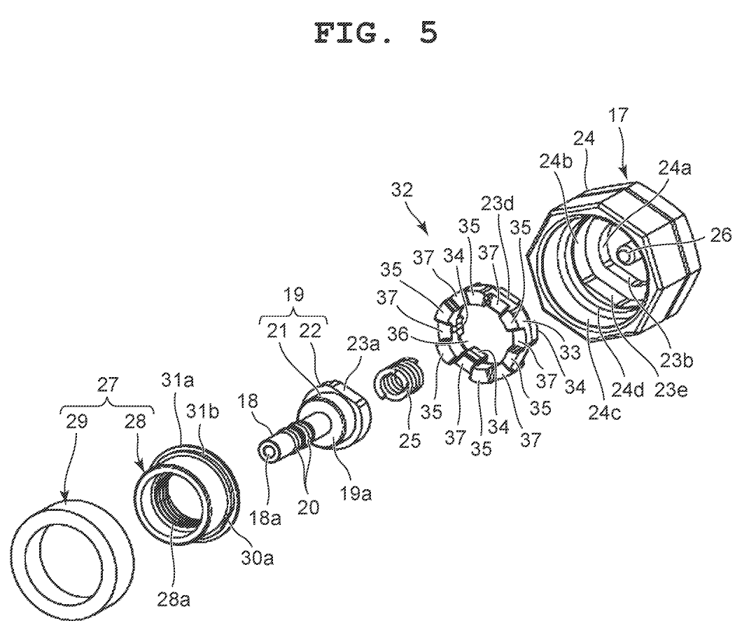

On opposing portions of the outer circumferential surface of the large-diameter outer cylindrical section 22 in the radial directions, first operation flat-surface sections 23a are provided, as shown in FIG.4 and FIG. 5 The large-diameter outer cylindrical section 22 is formed such that the outer diameter of its portion where the first operation flat-surface sections 23a are not provided, that is, the outer diameter of its outer end surface in the long axis directions is longer than the outer diameter of the male screw section 13b of the large-diameter cylindrical section 13, shorter than the outer diameter of the locking member 28, and longer than the inner diameter of the female screw section 28a of the locking member 28. As a result of this structure, the outer end surface of the female screw section 28a of the locking member 28 separably comes in contact with a stepped surface between the small-diameter inner cylindrical section 21 and the large-diameter outer cylindrical section 22, as FIGS. 2 and 3. Note that, since FIGS. 2 and 3 show a cross section perpendicular to the first operation flat-surface sections 23a, that is, an axial cross-section along the short axis of the outer end surface of the outer cylindrical section 22, the outer diameter of the large-diameter outer cylindrical section 22 has been drawn shorter than the outer diameter of the male screw section 13b of the large-diameter cylindrical section 13 and the inner diameter of the female screw section 28a of the locking member 28.

That is, in practice, the large-diameter outer cylindrical section 22 is formed such that the outer diameter of its outer end surface in the long axis directions is sufficiently longer than the outer diameter of the small-diameter inner cylindrical section 21, as shown in FIGS. 4 and 5. As a result, the shaft operation section 19 is structured such that, when the locking of the operation head section 17 by the locking mechanism 27 is released, the female screw section 28a of the locking member 28 is moved to be positioned around the outer circumference of the small-diameter inner cylindrical section 21, and the outer end portion of the female screw section 28a of the locking member 28 separably comes in contact with the stepped surface between the small-diameter inner cylindrical section 21 and the large-diameter outer cylindrical section 22, as shown in FIG. 3.

Also, the large-diameter outer cylindrical section 22 is arranged in the operation head section 17 in a manner to be slidable in an axial direction, and rotated together with the operation head section 17, as shown in FIGS. 2 and 3. More specifically, the outer circumferential surface of the large-diameter outer cylindrical section 22 and the inner circumferential surface of the operation head section 17 are provided with a first idling prevention section 23 for rotating the large-diameter outer cylindrical section 22 by the operation head section 17 via a buffering member 32 which is described later.

On the other hand, the operation head section 17 includes a cover section 24 into which the shaft operation section 19 of the operation shaft section 16 is inserted and which covers the large-diameter cylindrical section 13 of the cylindrical member 10, and a spring member 25 which is an energizing member for forcing the cover section 24 in a direction to be pressed outside the wristwatch case 1, as shown in FIGS. 2 and 5. The cover section 24 is made of a metal such as titanium alloy, and has a substantially cylindrical shape whose outer end is closed.

This cover section 24 has a substantially circular shape whose outer diameter is sufficiently longer than that of the large-diameter cylindrical section 13 of the cylindrical member 10, and about two-thirds of the vertical length of the wristwatch case 1, as shown in FIGS. 2 and 5 Also, this cover section 24 includes a small-diameter hole section 24a into which the shaft operation section 19 of the operation shaft section 16 is inserted, a middle-diameter hole section 24b in which the buffering member 32 described later is arranged, and a large-diameter hole section 24c into which the large-diameter cylindrical section 13 of the cylindrical member 10 and the locking mechanism 27 are inserted so as to be covered.

The first idling prevention section 23 includes the first operation flat-surface sections 23a (refer to FIG. 4) formed on the outer circumferential surface of the outer cylindrical section 22 of the shaft operation section 19, first small-diameter flat-surface sections 23b (refer to FIG. 5) formed on the inner circumferential surface of the small-diameter hole section 24a in the cover section 24 of the operation head section 17, first buffering inner-circumferential flat-surface sections 23c (refer to FIG. 3) formed on the inner circumferential surface of the buffering member 32, first buffering outer-circumferential flat-surface sections 23d (refer to FIG. 4) formed on the outer circumferential surface of the buffering member 32, and first middle-diameter flat-surface sections 23e (refer to FIG. 5) formed on the inner circumferential surface of the middle-diameter hole section 24b of the cover section 24, as shown in FIGS. 2 to 5.

The first small-diameter flat-surface sections 23b of the cover section 24 are pressed corresponding to the first operation flat-surface sections 23a of the large-diameter outer cylindrical section 22 and the first buffering inner-circumferential flat-surface sections 23c of the buffering member 32, as shown in FIGS. 2, 3, and 5. Here, the first operation flat-surface sections 23a of the large-diameter outer cylindrical section 22 come in contact with the first small-diameter flat-surface sections 23b of the cover section 24 only when the operation head section 17 is in a state of being locked to the cylindrical member 10 by the locking mechanism 27 described later.

Also, the first buffering inner-circumferential flat-surface sections 23c of the buffering member 32 come in contact with the first small-diameter flat-surface sections 23b of the cover section 24 in both the locked state by the locking mechanism 27 described later and the lock released state, as shown in FIGS. 2 and 3. The first buffering outer-circumferential flat-surface sections 23d of the buffering member 32 are pressed corresponding to the first middle-diameter flat-surface sections 23e of the cover section 24, as shown in FIG. 5.

As a result, the first idling prevention section 23 is structured such that, when the locking by the locking mechanism 27 described later is released, the operation head section 17 and the buffering member 32 become relatively slidable in an axial direction and the operation head section 17 becomes integrally rotatable without being idle, with the first operation flat-surface sections 23a of the outer cylindrical section 22 and the first buffering inner-circumferential flat-surface sections 23c of the buffering member 32 corresponding to and being in contact with each other and the first buffering outer-circumferential flat-surface sections 23d of the buffering member 32 and the first middle-diameter flat-surface sections 23e of the middle-diameter hole section 24b corresponding to and being in contact with each other, as shown in FIG. 3.

The outer cylindrical section 22 does not move at the moment when the locking by the locking mechanism 27 is released, as shown in FIG. 3. However, when the locking is released and the operation member 11 is being slid outward after being pushed by the spring member 25 (when the switch of the winder which is the switch device 4 is ON), the large-diameter outer cylindrical section 22 is slid together with the operation head section 17 and the buffering member 32.

In the cover section 24, a spring guide section 26 is formed, as shown in FIGS. 2, 3, and 5. This spring guide section 26, which is to guide the spring member 25, has a round bar shape, and formed on a substantially central portion of an inner end surface on the outer side of the small-diameter hole section 24a of the cover section 24, in an axial direction of the cover section 24. Also, this spring guide section 26 is formed such that its outer diameter is, for example, substantially equal to that of the shaft body section 18.

Moreover, this spring guide section 26 is formed such that its axial length is shorter than that of the hollow recess section 19b of the shaft operation section 19, as shown in FIGS. 2, 3, and 5. As a result, when the shaft operation section 19 is inserted into the small-diameter hole section 24a of the cover section 24, this spring guide section 26 is arranged in the hollow recess section 19b of the shaft operation section 19 without coming in contact with the hollow recess section 19b.

The spring member 25 is a coil spring which is arranged in the hollow recess section 19b of the shaft operation section 19 while being arranged around the outer circumference of the spring guide section 26, as shown in FIGS. 2 to 5. More specifically, this spring member 25 is formed such that its inner diameter is slightly longer than the outer diameter of the spring guide section 26 and its outer diameter is shorter than the inner diameter of the hollow recess section 19b of the shaft operation section 19. One end of this spring member 25 comes in contact with the bottom section 19a in the hollow recess section 19b of the shaft operation section 19, and the other end comes in contact with the inner end surface of the cover section 24 on the outer side.

That is, the spring member 25, which forces the cover section 24 in a direction to be pressed toward the outside of the wristwatch case 1, is compressed in an axial direction when the cover section 24 is locked by the locking mechanism 27, and released in an axial direction so as to press the cover section 24 toward the outside of the wristwatch case 1 when the locking of the cover section 24 by the locking mechanism 27 is released, as shown in FIGS. 2 to 5.

The operation shaft section 16 is structured such that the winding core (not shown in the drawings) having a square bar shape is inserted into a tubular (rectangular, cylindrical, or the like) connection hole 18a formed in an inner end portion of the shaft body section 18, as shown in FIGS. 2 and 3. As a result, the winding core is structured such that, when the operation shaft section 16 is slid and rotated by an operation performed on the operation head section 17, this winding core is slid and rotated together with the operation shaft section 16.

Although not shown in the drawings, the winding core is structured to be idle relative to the timepiece module 7 when pressed into the timepiece module 7. Also, the winding core is structured such that, when pulled one step outward with locking by the locking mechanism 27 being released, this winding core is connected to the timepiece module 7 and rotated in response to a rotation operation performed on the operation head section 17, whereby time correction and function setting or selection such as mode switching can be performed.

That is, the operation shaft section 16 is structured such that, when the winding core (not shown in the drawings) is pressed into the timepiece module 7 by the shaft body section 18 being pressed into the inner side of the wristwatch case 1, released from being connected to the timepiece module 7, and rotated by the shaft operation section 19 being rotated, this rotation is not transmitted to the timepiece module 7, whereby time correction and function setting or selection such as mode switching cannot be performed, as shown in FIG. 2.

Also, the operation shaft section 16 is structured such that, when the shaft body section 18 is pulled toward the outside of the wristwatch case 1 in the state shown in FIG. 3, and the winding core (not shown in the drawings) is slid in the direction to be pulled out of the timepiece module 7, connected to the timepiece module 7, and rotated by the shaft operation section 19 being rotated, this rotation is transmitted to the timepiece module 7, whereby time correction and function setting or selection such as mode switching can be performed.

On the other hand, the locking mechanism 27 includes the locking member 28 which is locked to the large-diameter cylindrical section 13 of the cylindrical member 10 by a rotation operation, and a rotation transmission member 29 to which the locking member 28 is attached in a manner to be slidable in an axial direction and which rotates the locking member 28 in response to a rotation operation performed on the operation member 11, as shown in FIGS. 2 to 5. The rotation transmission member 29 is structured to be slidable with respect to the locking member 28 in an axial direction. The locking member 28, which has a substantially cylindrical shape and is made of a metal such as stainless steel, is arranged on the inner circumferential surface of the rotation transmission member 29.

This locking member 28 is formed such that its axial length is substantially equal to that of the large-diameter cylindrical section 13, as shown in FIGS. 2 to 5. Also, this locking member 28 has the female screw section 28a formed on the outer end side of its inner circumferential surface. Into this female screw section 28a, the male screw section 13b formed on the outer circumferential surface of the large-diameter cylindrical section 13 of the cylindrical member 10 is screwed. As a result, when the female screw section 28a is screwed onto the male screw section 13b, this locking member 28 is arranged such that its inner end portion is pressed against the contact cylindrical section 13a of the large-diameter cylindrical section 13 and its outer end surface projects further than the outer end surface of the large-diameter cylindrical section 13 toward the outer side of the wristwatch case 1.

Also, this locking member 28 is formed such that the outer diameter of a portion excluding a later-described large-diameter flange section 31a on its outer end portion is longer than the inner diameter of the small-diameter cover section 24a of the operation head section 17 and shorter than the inner diameter of the large-diameter cover section 24b of the operation head section 17, as shown in FIGS. 2 t o 5. As a result of the structure of this locking member 28, when the locking of the large-diameter cylindrical section 13 of the cylindrical member 10 is released, the cover section 24 of the operation head section 17 is pressed toward the outside of the wristwatch case 1 by the spring force of the spring member 25.

Accordingly, in the case of this locking member 28, when the cover section 24 of the operation head section 17 is pressed toward the outside of the wristwatch case 1 by the spring force of the spring member 25, the female screw section 28a of the locking member 28 is moved and positioned corresponding to the outer circumference of the small-diameter inner cylindrical section 21 of the shaft operation section 19, and an inner circumferential surface portion of the locking member 28 on the inner side is moved and positioned corresponding to the outer circumference of the male screw section 13b of the large-diameter cylindrical section 13, as shown in FIGS. 2 to 5. In this state, the outer end of the female screw section 28a of the locking member 28 is in contact with the stepped surface between the small-diameter inner cylindrical section 21 and the large-diameter outer cylindrical section 22.

The rotation transmission member 29 is made of a metal such as stainless steel and has a cylindrical shape, as shown in FIGS. 2 to 5. This rotation transmission member 29 is formed such that its inner diameter is substantially equal to the outer diameter of the locking member 28, and its axial length is shorter than that of the locking member 28. As a result, when the locking member 28 is locked to the large-diameter cylindrical section 13 and the inner end of the locking member 28 is pressed against the contact cylindrical section 13a of the large-diameter cylindrical section 13, a space is formed between the inner end surface of the rotation transmission member 29 and the outer end surface of the case main body 1a. Note that, even in a structure where the axial length of the rotation transmission member 29 is equal to or longer than that of the locking member 28, a space can be formed between the rotation transmission member 29 and the case main body 1a if the rotation transmission member 29 side of the case main body 1a is trimmed.

Also, this rotation transmission member 29 is formed such that its outer diameter is equal to or slightly longer than the inner diameter of the large-diameter hole section 24c in the cover section 24 of the operation head section 17, as shown in FIGS. 2 to 5. Accordingly, the rotation transmission member 29 having the locking member 28 arranged therein is fitted into and fixed in the large-diameter hole section 24c in the cover section 24 of the operation head section 17 by press fitting. By this press fitting method being used, they can be separated. However, a method other than this press fitting method may be used as the method of fixing the rotation transmission member 29. For example, adhesion, welding, caulking, or the like may be used as the fixing method. As a result of this structure, this rotation transmission member 29 is not slid with respect to the cover section 24, and is structured to integrally rotate with the operation head section 17, transmit the rotation to the locking member 28, and thereby rotate the locking member 28.

On the other hand, on the inner circumferential surface of the large-diameter hole section 24c of the cover section 24, a positioning restriction section 24d is formed which restricts a position to which the rotation transmission member 29 is pressed in the cover section 24 of the operation head section 17, as shown in FIG. 3. Accordingly, when being fitted into and fixed in the large-diameter hole section 24c of the cover section 24 by press fitting, the rotation transmission member 29 is positionally restricted by the outer end surface of the rotation transmission member 29 on the cover section 24 side coming in contact with the position restriction section 24d. For convenience of the press-fitting process, the inner end surface of the rotation transmission member 29 on the wristwatch case 1 side and the inner end surface of the cover section 24 on the same side are flush with each other.

Also, the locking member 28 and the rotation transmission member 29 are structured to be relatively slid and integrally rotated by a second idling prevention section 30, as shown in FIGS. 4 and 5. More specifically, the second idling prevention section 30 includes second locking flat-surface sections 30a formed on the outer circumferential surface of a later-described small-diameter stepped section 31b of the locking member 28, and second transmission flat-surface sections 30b formed opposing each other on the inner circumferential surface of a later-described small-diameter cutout section 31c of the rotation transmission member 29 and pressed corresponding to the second locking flat-surface sections 30a of the locking member 28.

As a result, the second idling prevention section 30 is structured such that, when the second locking flat-surface sections 30a of the locking member 28 and the second transmission flat-surface sections 30b of the rotation transmission member 29 correspond to and come in contact with each other, the locking member 28 and the rotation transmission member 29 are relatively slidable in an axial direction and are integrally rotated without being idle, as shown in FIGS. 4 and 5.

Also, the locking mechanism 27 includes a stopper section 31 which prevents the locking member 28 from slipping out of the rotation transmission member 29 toward the wristwatch case 1 side, as shown in FIGS. 2 to 5. This stopper section 31 includes the large-diameter flange section 31a formed on an outer end portion of the locking member 28, the small-diameter stepped section 31b whose outer diameter is shorter than the outer diameter of the large-diameter flange section 31a, and the small-diameter cutout section 31c formed in the inner circumferential surface of the rotation transmission member 29. The large-diameter flange section 31a is formed projecting from the outer circumferential surface of the outer end portion of the locking member 28. Also, the small-diameter stepped section 31b is formed projecting on an outer circumferential surface portion on the outer end side of the locking member 28 in a manner to be one step higher, and the small-diameter cutout section 31c is formed in an outer end portion of the rotation transmission member 29 in a manner to be one step lower.

The outer diameter of the large-diameter flange section 31a of the locking member 28 is longer than the inner diameter of the rotation transmission member 29, and shorter than the outer diameter of the rotation transmission member 29 and the inner diameter of the position restriction section 24d formed on the inner circumferential surface of the large-diameter hole section 24c of the cover section 24, as shown in FIGS. 2 to 5. Also, the axial length of the large-diameter flange section 31a is, for example, substantially equal to the protruding length of the female screw section 28a from the outer end of the cylindrical member 10 in the locked state where the female screw section 28a of the locking member 28 has been screwed onto the male screw section 13b of the large-diameter cylindrical section 13.

The outer diameter of the small-diameter stepped section 31b of the locking member 28 is shorter than the outer diameter of the large-diameter flange section 31a, and longer than the outer diameter of the locking member 28, as shown in FIGS. 2 to 5. In addition, the axial length of the small-diameter stepped section 31b is substantially equal to that of the large-diameter flange section 31a. Also, the inner diameter of the small-diameter cutout section 31c of the rotation transmission member 29 is substantially equal to the outer diameter of the small-diameter stepped section 31b. In addition, the axial length of the small-diameter cutout section 31c is substantially equal to that of the small-diameter stepped section 31b.

As a result, the stopper section 31 is structured such that the inner end surface of the large-diameter flange section 31a of the locking member 28 comes in contact with the outer end surface of the rotation transmission member 29 and the small-diameter stepped section 31b is inserted into the small-diameter cutout section 31c of the rotation transmission member 29 in both the locked state where the female screw section 28a has been screwed onto the male screw section 13b and the released state where the female screw section 28a has been unscrewed from the male screw section 13b, as shown in FIGS. 2 to 3.

That is, this stopper section 31 is structured such that, when the rotation transmission member 29 is moved towards the outer side of the wristwatch case 1 together with the cover section 24 of the operation head section 17, the inner end surface of the large-diameter flange section 31a of the locking member 28 comes in contact with the outer end surface of the rotation transmission member 29, whereby the locking member 28 is moved together with the rotation transmission member 29 without slipping out of the rotation transmission member 29 toward the wristwatch case 1 side, as shown in FIG. 3.

In the middle-diameter hole section 24b in the cover section 24 of the operation head section 17, the buffering member 32 is provided, as shown in FIGS. 2 to 6. This buffering member 32 is made of synthetic resin, metal, or the like and functions to disperse external impacts exerted on the operation head section 17 of the operation member 11 in the locked state where the female screw section 28a has been screwed onto the male screw section 13b.

More specifically, in the case where the material of the buffering member 32 is synthetic resin, the buffering member 32 can be inexpensively formed using, for example, a highly rigid synthetic resin such as polyamide resin or an elastic synthetic resin such as urethane resin. In the case where the material of the buffering member 32 is metal, the buffering member 32 can be inexpensively formed using, for example, a soft metal such as aluminum or copper or a highly rigid metal such as stainless steel.

This buffering member 32 includes a cylindrical main body section 33 which is arranged in the operation head section 17 of the operation member 11, a plurality of first projection sections 34 which projects from the cylindrical main body section 33 toward the side opposite to the wristwatch case 1, that is, the outside of the wristwatch case 1 in an axial direction of the operation member 11, and a plurality of second projection sections 35 which projects from the cylindrical main body section 33 toward the wristwatch case 1 side in an axial direction of the operation member 11, as shown in FIGS. 4 to 6.

The cylindrical main body section 33 is formed such that its inner diameter is substantially equal to the outer diameter of the large-diameter outer cylindrical section 22 of the shaft operation section 19 in the operation head section 17, as shown in FIGS. 2 to 6. In addition, this main body section 33 is formed such that its outer diameter is substantially equal to the inner diameter of the middle-diameter hole section 24b formed in the cover section 24 of the operation head section 17. Moreover, this main body section 33 is formed such that its axial length is, for example, shorter than and substantially half the axial length of the middle-diameter hole section 24b.

On the inner circumferential surface of the main body section 33, the first buffering inner-circumferential flat-surface sections 23c (refer to FIG. 3) are formed which correspond to the first operation flat-surface sections 23a of the first idling prevention section 23, as shown in FIGS. 2 and 3. As a result, by the first buffering inner-circumferential flat-surface sections 23c of the main body section 33 coming in contact with the first operation flat-surface sections 23a of the first idling prevention section 23, the rotational position of the main body section 33 in circumferential directions is restricted, whereby the main body section 33 is rotated integrally with the shaft operation section 19 of the operation shaft section 16 while being slidable in an axial direction.

Also, on the outer circumferential surface of the main body section 33, the first buffering outer-circumferential flat-surface sections 23d (refer to FIG. 3) are formed which correspond to the first middle-diameter flat-surface sections 23e of the first idling prevention section 23 formed on the inner circumferential surface of the middle-diameter hole section 24b in the cover section 24, as shown in FIGS. 2, 3, and 5. As a result, by the first buffering outer-circumferential flat-surface sections 23d of the main body section 33 coming in contact with the first middle-diameter flat-surface sections 23e of the first idling prevention section 23, the rotational position of the main body section 33 in circumferential directions is restricted, whereby the main body section 33 is rotated integrally with the cover section 24 of the operation head section 17 while being slidable in an axial direction.

The plurality of first projection sections 34 is formed such that the inner diameters corresponding thereto are equal to the inner diameter of the main body section 33 and the outer diameters corresponding thereto are equal to the outer diameter of the main body section 33, as shown in FIGS. 2 to 6. On inner circumferential surfaces of the first projection sections 34 as well, the first buffering inner-circumferential flat-surface sections 23c (refer to FIG. 3) corresponding to the first operation flat-surface sections 23a of the first idling prevention section 23 are formed extending to the main body section 33, as shown in FIG. 3. These first projection sections 34 are arranged in the middle-diameter hole section 24b of the cover section 24 with their outer end surfaces being in contact with a stepped surface between the small-diameter hole section 24a and the middle-diameter hole section 24b in the cover section 24, as shown in FIGS. 2 to 6.

Also, the plurality of second projection sections 35 is formed such that the inner diameters corresponding thereto are slightly longer than the inner diameter of the main body section 33 and the outer diameters corresponding thereto are equal to the outer diameter of the main body section 33, as shown in FIGS. 2 to 6. These second projection sections 35 are arranged in the large-diameter hole section 24c of the cover section 24 with their inner end surfaces being in contact with the outer end surface of the large-diameter flange section 31a of the locking member 28.

The buffering member 32 is formed such that the plurality of first projection sections 34 and the plurality of second projection sections 35 are positioned in a manner not to overlap with each other in axial directions of the main body section 33. That is, in the case of this buffering member 32, the plurality of first projection sections 34 and the plurality of second projection sections 35 are alternately formed in the circumferential directions of the main body section 33. As a result, in interspaces among the plurality of first projection sections 34 of the buffering member 32, first recess sections 36 are formed corresponding to the plurality of second projection sections 35 in an axial direction of the main body section 33. Also, in interspaces among the plurality of second projection sections 35, second recess sections 37 are formed corresponding to the plurality of first projection sections 34 in an axial direction of the main body section 33.

As a result of this structure, when an external impact is exerted on the operation head section 17 of the operation member 11 and transmitted to the plurality of first projection sections 34, this impact is dispersed to the plurality of second projection sections 35 by the interspaces formed by the plurality of second recess sections 37 and thereby buffered, as shown in FIGS. 2 to 6. That is, this buffering member 32 is structured such that, even though impacts exerted on the plurality of first projection sections 34 are directly transmitted to the main body section 33, since the plurality of second recess sections 37 correspond to the plurality of first projection sections 34 in the axial direction of the main body section 33, these impacts exerted on the plurality of first projection sections 34 are not directly transmitted to the locking member 28 by the interspaces formed by the plurality of second recess sections 37.

That is, this buffering member 32 functions such that, when the plurality of first projection sections 34 receives an external impact in the axial direction of the operation member 11, a stress therefrom is concentrated on each boundary section 33a of the main body section 33 between each first projection section 34 and each second projection sections 35, whereby each boundary section 33a of the main body section 33 is flexurally deformed, and the impact exerted on the plurality of first projection sections 34 is absorbed by this elastic or resilient deformation of each boundary section 33a of the main body sections 33, as shown in FIGS. 2 to 6.

Here, about six first projection sections 34 and six second projection sections 35 should preferably formed in the circumferential direction. However, three to nine first projection sections 34 and three to nine second projection sections 35 may be formed. Similarly, about six first recess sections 36 and six second recess sections 37 should preferably formed in the circumferential direction. However, three to nine first recess sections 36 and three to nine second recess sections 37 may be formed.

Accordingly, in the case where the buffering member 32 is formed using a highly rigid synthetic resins such as polyamide or a highly rigid metal such as stainless steel, the number of first projection sections 34 and the number of second projection section 35 are decreased, and the main body section 33, each first projection section 34, and each second projection section 35 are thinly formed (their lengths in the radial directions are shortened), whereby the buffering member 32 is preferably formed in an optimal condition where the plurality of boundary sections 33a is easily deformed elastically or resiliently, as shown in FIGS. 2, 3, and 6.

Also, in the case where the buffering member 32 is formed using an elastic synthetic resin such as urethane resin or a soft metal such as aluminum or copper, the number of first projection sections 34 and the number of second projection section 35 are increased or their widths are changed so that the main body section 33, each first projection section 34, and each second projection section 35 are thickly formed (their lengths in the radial directions are lengthened), whereby the buffering member 32 is preferably formed in an optimal condition where the plurality of boundary sections 33a is difficult to be elastically or resiliently deformed. That is, the thicknesses of the main body section 33, the first projection sections 34, and the second projection sections 35 and the number of them should preferably be determined as necessary in accordance with the rigidity and strength of their materials.

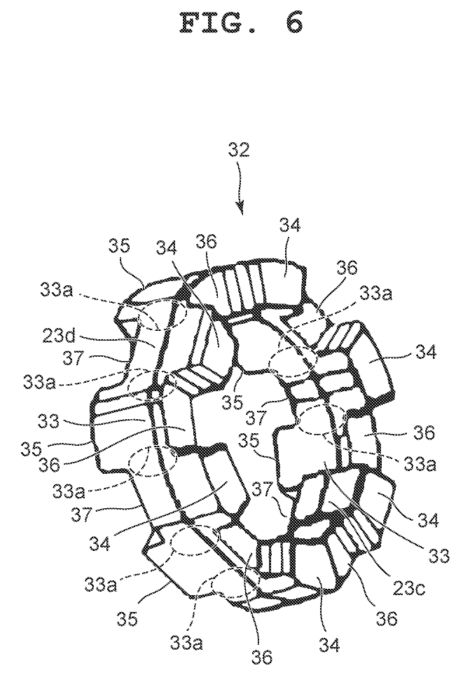

As a result of this structure, when the cover section 24 of the operation head section 17 is subjected to an external impact with the operation head section 17 being locked by the locking mechanism 27, the buffering member 32 is held and compressed between the large-diameter hole section 24c of the cover section 24 and the locking member 28 of the locking mechanism 27 in the axial directions, whereby the external impact is dispersed and buffered, as shown in FIGS. 2 and 6.

That is, when an external impact is exerted on the plurality of first projection sections 34 with the female screw section 28a of the locking member 28 of the locking mechanism 27 being screwed onto the male screw section 13b of the large-diameter cylindrical section 13, the buffering member 32 disperses the impact to the plurality of second projection sections 35 by the interspaces formed by the plurality of second recess sections 37 and thereby buffers the impact, as shown in FIGS. 2 and 6.

More specifically, the buffering member 32 is structured such that, even though an impact exerted on the plurality of first projection sections 34 is directly transmitted to the main body section 33, since the plurality of second recess sections 37 is corresponding to the plurality of first projection sections 34 in the axial direction of the main body section 33, the impact exerted on the plurality of first projection sections 34 is not directly transmitted to the locking member 28 by the interspaces formed by the plurality of second recess sections 37, as shown in FIGS. 2 and 6.

That is, in the case of this buffering member 32, when the plurality of first projection sections 34 receives an external impact in the axial direction of the operation member 11, a stress therefrom is concentrated on each boundary section 33a of the main body section 33 between each first projection section 34 and each second projection sections 35, whereby each boundary section 33a is flexurally deformed, and the impact exerted on the plurality of first projection sections 34 is absorbed by this elastic or resilient deformation of each boundary section 33a, as shown in FIGS. 2 to 6.

In this switch device 4, when the cover section 24 of the operation head section 17 is rotated with the operation head section 17 being pressed onto the large-diameter cylindrical section 13 of the cylindrical member 10 against the spring force of the spring member 25 so as to lock the operation head section 17 to the cylindrical member 10 by the locking mechanism 27, the rotation transmission member 29 is rotated with the rotation of the cover section 24 and rotates the locking member 28, whereby the female screw section 28a of the locking member 28 is screwed onto the male screw section 13b of the large-diameter cylindrical section 13 of the cylindrical member 10, as shown in FIG. 2.

That is, this switch device 4 is structured such that, when the female screw section 28a of the locking member 28 is to be screwed onto the male screw section 13b of the large-diameter cylindrical section 13 of the cylindrical member 10, the second locking flat-surface sections 30a of the second idling prevention section 30 on the locking member 28 correspond to and come in contact with the second transmission flat-surface sections 30b of the rotation transmission member 29, and the rotation transmission member 29 is rotated by a rotation operation performed on the operation head section 17 and rotates the locking member 28, whereby the female screw section 28a of the locking member 28 is screwed onto the male screw section 13b of the large-diameter cylindrical section 13 of the cylindrical member 10, as shown in FIG. 2.

Also, in this switch device 4, when the locking of the operation head section 17 with respect to the large-diameter cylindrical section 13 of the cylindrical member 10 is to be released, the cover section 24 of the operation head section 17 is rotated in the reverse direction, whereby the female screw section 28a of the locking member 28 is unscrewed from the male screw section 13b of the large-diameter cylindrical section 13 of the cylindrical member 10, as shown in FIGS. 2 and 3. As a result, by the spring force of the spring member 25, the cover section 24 of the operation head section 17 is pressed toward the outside of the wristwatch case 1 together with the locking mechanism 27.

Moreover, in this switch device 4, when the cover section 24 and the locking mechanism 27 are to be pressed toward the outside of the wristwatch case 1 by the spring force of the spring member 25 after the locking of the operation head section 17 with respect to the large-diameter cylindrical section 13 of the cylindrical member 10 is released, the locking member 28 and the rotation transmission member 29 are moved toward the outside of the wristwatch case 1 together with the cover section 24 by the stopper section 31 of the locking mechanism 27, as shown in FIG. 3.

That is, in this switch device 4, when the cover section 24 of the operation head section 17 and the locking mechanism 27 are to be pressed toward the outside of the wristwatch case 1 by the spring force of the spring member 25 after the locking of the operation head section 17 with respect to the cylindrical member 10 is released, the outer end surface of the rotation transmission member 29 at the stopper section 31 comes in contact with the inner end surface of the large-diameter flange section 31a of the locking member 28, and the outer end surface of the small-diameter cutout section 31c of the rotation transmission member 29 comes in contact with the inner end surface of the small-diameter stepped section 31b of the locking member 28, as shown in FIG. 3.

Here, the operation shaft section 16 does not slide in the axial directions, and the female screw section 28a of the locking member 28 and the rotation transmission member 29 are moved to the outer circumference of the small-diameter inner cylindrical section 21 of the shaft operation section 19 of the operation shaft section 16 by the spring force of the spring member 25, whereby the outer end of the female screw section 28a of the locking member 28 is pressed against the stepped surface between the small-diameter inner cylindrical section 21 and the large-diameter outer cylindrical section 22.

Also, when the cover section 24 of the operation head section 17 and the locking mechanism 27 are to be pressed toward the outside of the wristwatch case 1 by the spring force of the spring member 25, the first buffering outer-circumferential flat-surface sections 23d on the outer circumferential surface of the buffering member 32 correspond to and come in contact with the first middle-diameter flat-surface sections 23e of the first idling prevention section 23 in the middle-diameter hole section 24b of the cover section 24, the first buffering inner-circumferential flat-surface sections 23c on the inner circumferential surface of the buffering member 32 correspond to and come in contact with the first operation flat-surface sections 23a on the outer cylindrical section 22 of the shaft operation section 19 of the operation shaft section 16. As a result, the rotation of the cover section 24 is transmitted via the buffering member 32, whereby the shaft operation section 19 is rotated.

Also, in this switch device 4, when the locking of the operation head section 17 with respect to the cylindrical member 10 is released, and the operation head section 17 is pulled one step further toward the outside of the wristwatch case 1 with the cover section 24 of the operation head section 17 and the locking mechanism 27 being pressed toward the outside of the wristwatch case 1 by the spring force of the spring member 25, the locking member 28 pulls the operation shaft section 16 toward the outside of the wristwatch case 1 because the outer end surface of the female screw section 28a of the locking member 28 is in contact with the stepped surface between the small-diameter inner cylindrical section 21 and the large-diameter outer cylindrical section 22 in the shaft operation section 19, as shown in FIG. 3.

Moreover, in this switch device 4, when the cover section 24 of the operation head section 17 pulls the locking mechanism 27 and the operation shaft section 16 toward the outside of the wristwatch case 1 in the state shown in FIG. 3, the winding core (not shown in the drawings) connected to the connection hole 18a of the shaft body section 18 is slid in the direction to be pulled out of the clock module 7, and thereby connected to the clock module 7.

Furthermore, in this switch device 4, when the winding core (not shown in the drawings) is slid in the direction to be pulled out of the clock module 7 in the state shown in FIG. 3, and the operation head section 17 is rotated with the winding core being connected to the clock module 7, this rotation is transmitted to the winding core via the operation shaft section 16, and the rotation of the winding core is transmitted to the timepiece module 7, whereby time correction and function setting or selection such as mode switching can be performed.

Next, a procedure for assembling this wristwatch is described.

In the assembly, first, the watch glass 5 is attached to the upper opening of the wristwatch case 1 together with the glass packing 5a. In this state, the push-button switches 3 are attached to the two o’clock side, four o’clock side, eight o’clock side, and ten o’clock side of the wristwatch case 1, respectively, and the cylindrical member 10 of the switch device 4 is attached to the through hole 8 on the three o’clock side of the wristwatch case 1.

In this attachment, the small-diameter cylindrical section 12 of the cylindrical member 10 is inserted into the through hole 8 in the case main body 1a of the wristwatch case 1 from outside, and the inner end surface of the large-diameter cylindrical section 13 of the cylindrical member 10 is pressed against the outer surface of the case main body 1a. Here, the inner end portion of the small-diameter cylindrical section 12 of the cylindrical member 10 protrudes inside the case main body 1a of the wristwatch case 1.

In this state, the outer circumferential part of the inner end portion of the small-diameter cylindrical section 12 protruding inside the case main body 1a and the rim portion of the inner end of the through hole 8 of the case main body 1a are entirely fixed to each other by welding such as laser welding or brazing and Loctite. As a result, the cylindrical member 10 is firmly attached to the through hole 8 of the case main body 1a of the wristwatch case 1 so as not to slip out toward the outside of the wristwatch case 1. In addition, by this welding such as laser welding or brazing and Loctite, waterproofing between the outer circumferential surface of the cylindrical member 10 and the inner circumferential surface of the through hole 8 is achieved.

Then, the clock module 7 is mounted in the wristwatch case 1, and the operation member 11 is attached to the cylindrical member 10 of the switch device 4. Here, before this attachment, the plurality of waterproof rings 20 is attached to the outer circumferential surface of the shaft body section 18 of the operation shaft section 16. In this state, the operation head section 17 is attached to the shaft operation section 19 of the operation shaft section 16.

Here, the locking member 28 of the locking mechanism 27 is arranged on the small-diameter inner cylindrical section 21 at the outer circumference of the shaft operation section 19 of the operation shaft section 16 with the rotation transmission member 29 being arranged on the outer circumferential surface of the locking member 28 of the locking mechanism 27, and the buffering member 32 is arranged on the circumferential surface of the large-diameter outer cylindrical section 22 at the outer circumference of the shaft operation section 19. In this arrangement, the first buffering inner-circumferential flat-surface sections 23c of the first idling prevention section 23 extending from each first projection section 34 of the buffering member 32 to the main body section 33 are positioned corresponding to the first operation flat-surface sections 23a of the outer cylindrical section 22 of the shaft operation section 19.

In this state, the spring member 25 is arranged around the outer circumference of the spring guide section 26 formed in the cover section 24 of the operation head section 17, and the spring guide section 26 of the cover section 24 is inserted into the hollow recess section 19b in the shaft operation section 19 of the operation shaft section 16 together with the spring member 25. That is, the spring member 25 is arranged in the hollow recess section 19b in the shaft operation section 19 of the operation shaft section 16, and the shaft operation section 19 of the operation shaft section 16 is inserted around the outer circumference of the spring guide section 26 in the cover section 24 of the operation head section 17 together with the spring member 25. Here, the first operation flat-surface sections 23a of the first idling prevention section 23 formed on the outer circumferential surface of the outer cylindrical section 22 of the shaft operation section 19 and the first buffering inner-circumferential flat-surface sections 23c of the buffering member 32 are positioned corresponding to each other, and then the operation section 19 is inserted into the small-diameter hole section 24a of the cover section 24.

Also, here, the first buffering outer-circumferential flat-surface sections 23d formed on the outer circumferential surface of the buffering member 32 and the first middle-diameter flat-surface sections 23e formed on the inner circumferential surface of the middle-diameter hole section 24b of the cover section 24 are positioned corresponding to each other, and then the spring guide section 26 of the cover section 24 is inserted into the spring member 25 in the hollow recess section 19b of the shaft operation section 19 of the operation shaft section 16. As a result, the shaft operation section 19 is arranged in a manner to be rotatable integrally with the cover section 24 via the buffering member 32 and axially slidable in the cover section 24.

Then, the locking mechanism 27 is mounted in the large-diameter hole section 24c. Here, before this mounting operation, the locking member 28 of the locking mechanism 27 is inserted into and arranged in the rotation transmission member 29 such that the second locking flat-surface sections 30a of the second idling prevention section 30 formed on the outer circumferential surface of the locking member 28 and the second transmission flat-surface sections 30b formed on the inner circumferential surface of the rotation transmission member 29 are positioned corresponding to each other.

In this state, when inserted into the cylindrical rotation transmission member 29, the substantially cylindrical locking member 28 enters a state where this locking member 28 is slidable with respect to the rotation transmission member 29 and rotatable together with the rotation transmission member 29. In addition, here, the outer end surface of the rotation transmission member 29 comes in contact with the inner end surface of the large-diameter contact section 31a of the locking member 28 which constitutes the stopper section 31, and the small-diameter stepped section 31b of the locking member 28 is arranged in the small-diameter cutout section 31c of the rotation transmission member 29. As a result, the assembly of the locking mechanism 27 is achieved such that the locking member 28 does not slip out toward the wristwatch case 1 side.

When the locking mechanism 27 assembled as described above is to be mounted in the cover section 24 of the operation head section 17, first, the first buffering outer-circumferential flat-surface sections 23d of the buffering member 32 are positioned corresponding to the first middle-diameter flat-surface sections 23e of the middle-diameter hole section 24b of the cover section 24. Here, the buffering member 32 is arranged on the operation shaft section 16, and the cover section 24 is arranged thereon. Next, the bottom surface of the locking mechanism 27 is supported by a jig, and the top surface of the cover section 24 is pressed and crimped with the jig. As a result, the rotation transmission member 29 of the locking mechanism 27 is fitted into and fixed in the large-diameter hole section 24c of the cover section 24.

In this state, the cover section 24 of the operation head section 17 is pressed by the spring force of the spring member 25 toward the outside of the wristwatch case 1, as shown in FIG. 3. Accordingly, the female screw section 28a of the locking member 28 of the locking mechanism 27 is arranged on the outer circumferential surface of the small-diameter inner cylindrical section 21 of the shaft operation section 19 of the operation member 11, and the outer end of the female screw section 28a comes in contact with the stepped surface between the small-diameter inner cylindrical section 21 and the large-diameter outer cylindrical section 22. As a result, by the spring force of the spring member 25, the operation head section 17 of the operation member 11 is attached to the shaft operation section 19 of the operation shaft section 16 without slipping off the shaft operation section 19.

As described above, in this structure, the rotation transmission member 29 is press-fitted into and fixed in the cover section 24 such that they are unified. Therefore, even by the spring force of the spring member 25, the cover section 24 and the rotation transmission member 29 are not separated from each other. Also, the outer end surface of the rotation transmission member 29 comes in contact with the inner end surface of the large-diameter flange section 31a of the locking member 28, and the small-diameter stepped section 31b of the locking member 28 is inserted into and arranged in the small-diameter cutout section 31c of the rotation transmission member 29, whereby positional restriction in the axial directions is achieved.

Here, by the spring force of the spring member 25, each outer end surface of the plurality of first projection sections 34 of the buffering member 32 comes in contact with the stepped surface between the small-diameter hole section 24a and the middle-diameter hole section 24b, and the plurality of second projection sections 35 of the buffering member 32 comes in contact with the outer end surface of the locking member 28. As a result, the buffering member 32 is arranged while being held between the stepped surface between the small-diameter hole section 24a and the middle-diameter hole section 24b and the outer end surface of the large-diameter flange section 31a of the locking member 28.

Then, the shaft body section 18 of the operation shaft section 16 is inserted into the cylindrical member 10 from the outside of the wristwatch case 1. Here, before this insertion, the outer end portion of the winding core (not shown in the drawings) is fitted into and connected to the connection hole 18a formed in the inner end portion of the shaft body section 18 of the operation shaft section 16. In this state, the winding core is inserted into the cylindrical member 10 together with the operation shaft section 16, and inserted into and attached to the clock module 7.

Here, the winding core is slidably and rotatably attached to the inside of the clock module 7 with the locking mechanism 27 of the operation head section 17 being arranged close to the male screw section 13b of the large-diameter cylindrical section 13 of the cylindrical member 10. In this state, the winding core can be slid along with the slide movement of the operation shaft section 16 inserted into the cylindrical member 10, and rotated along with the rotation of the operation shaft section 16. As a result, the assembly of the switch device 4 is completed. Then, the back lid 6 is attached to the lower part of the wristwatch case 1 together with the waterproof packing 6a, whereby the assembly of the wristwatch is completed.

Next, the mechanism of the switch device 4 of this wristwatch is described.

When this wristwatch is to be used by being worn on an arm, first, the operation head section 17 of the switch device 4 is locked to the large-diameter cylindrical section 13 of the cylindrical member 10 by the locking mechanism 27. Here, the cover section 24 of the operation head section 17 is moved toward the large-diameter cylindrical section 13 against the spring force of the spring member 25, and the inner end of the female screw section 28a of the locking member 28 is pressed against the outer end of the male screw section 13b of the large-diameter cylindrical section 13.

In this state, when the cover section 24 is rotated, the rotation transmission member 29 of the locking mechanism 27 is rotated together with the cover section 24, and this rotation of the rotation transmission member 29 is transmitted to the locking member 28 by the second idling prevention section 30, whereby the locking member 28 is rotated. By this rotation of the locking member 28, the female screw section 28a of the locking member 28 is screwed onto the male screw section 13b of the large-diameter cylindrical section 13 and tightened.

Here, the operation shaft section 16 is not pressed into the cylindrical member 10, and the bottom section 19a which is the inner end part of the shaft operation section 19 of the operation shaft section 16 receives the spring force of the spring member 25, whereby the spring member 25 is compressed, as shown in FIG. 2. Accordingly, the state where the bottom section 19a of the shaft operation section 19 is at a position close to the outer end of the large-diameter cylindrical section 13, that is, the outer end of the male screw section 13b is maintained. As a result, the operation head section 17 of the switch device 4 is locked to the large-diameter cylindrical section 13 of the cylindrical member 10.

Here, since the bottom section 19a which is the inner end part of the shaft operation section 19 of the operation shaft section 16 remains at the position close to the outer end of the large-diameter cylindrical section 13 with the spring member 25 being compressed, the winding core (not shown in the drawings) fitted into and connected to the connection hole 18a formed in the inner end portion of the shaft body section 18 of the operation shaft section 16 is not pressed into the clock module 7. Also, in this state, since the operation head section 17 has been locked to the large-diameter cylindrical section 13 of the cylindrical member 10, the operation member 11 is not rotated, and therefore the winding core is not rotated inside the clock module 7.

In this state, when the cover section 24 of the operation head section 17 is subjected to an external impact, the stepped portion between the large-diameter cover section 24b and the small-diameter cover section 24a is pressed against the buffer member 32 by the impact. As a result, the buffer member 32 is held and compressed between the stepped portion between the large-diameter cover section 24b and the small-diameter cover section 24a and the outer end of the locking member 28 of the locking mechanism 27, whereby the impact is dispersed and buffered by the buffer member 32.

More specifically, when an external impact is exerted on the operation head section 17 of the operation member 11 and transmitted to the plurality of first projection sections 34, the buffering member 32 disperses this impact to the plurality of second projection sections 35 by the interspaces formed by the plurality of second recess sections 37, and thereby buffers the impact. That is, this buffering member 32 is structured such that, even though impacts exerted on the plurality of first projection sections 34 are directly transmitted to the main body section 33, since the plurality of second recess sections 37 have been formed corresponding to the plurality of first projection sections 34 in the axial direction of the main body section 33, these impacts exerted on the plurality of first projection sections 34 are dispersed to the plurality of second projection sections 35 by the interspaces formed by the plurality of second recess sections 37. As a result of this structure, impacts exerted on the buffering member 32 are not directly transmitted to the locking member 28.

Also, this buffering member 32 is structured such that, when the plurality of first projection sections 34 receives an external impact in the axial direction of the operation member 11, a stress therefrom is concentrated on each boundary section 33a of the main body section 33 between each first projection section 34 and each second projection sections 35, whereby each boundary section 33a is flexurally deformed, and the impact exerted on the plurality of first projection sections 34 is buffered by this elastic or resilient deformation of each boundary section 33a of the main body sections 33.

Here, even when the buffered impact in the axial direction of the operation member 11 is transmitted to the locking member 28, since the inner end of the locking member 28 has been pressed against the contact cylindrical section 13a of the large-diameter cylindrical section 13 of the cylindrical member 10 fixed to the case main body 1a, an undesirable movement of the locking member 28 in the axial direction of the operation member 11 due to the impact in the axial direction of the operation member 11 does not occur.

As a result of this structure, the female screw section 28a and the male screw section 13b are prevented from being damaged by impacts. Also, since impacts exerted on the cover section 24 are buffered by the spring member 25 as well, the operation shaft section 16 is not damaged. Accordingly, the winding core (not shown in the drawings) is not pushed into the timepiece module 7 by impacts, and the timepiece module 7 is prevented from being damaged.

On the other hand, in the case of time correction and function setting or selection such as mode switching, first, the locking of the operation head section 17 with respect to the large-diameter cylindrical section 13 of the cylindrical member 10 by the locking mechanism 27 is released. Here, the cover section 24 of the operation head section 17 is rotated in the reverse direction so as to rotate the rotation transmission member 29 of the locking mechanism 27, whereby the rotation transmission member 29 rotates the locking member 28 in the same direction by the second idling prevention section 30.

Subsequently, when the locking member 28 is rotated, the female screw section 28a of the locking member 28 is unscrewed from the male screw section 13a of the large-diameter cylindrical section 13. Then, the operation head section 17 is pressed by the spring force of the spring member 25 toward the outside of the wristwatch case 1, and the female screw section 28a of the locking member 28 is moved and corresponds to the outer circumference of the small-diameter inner cylindrical section 21 of the of the shaft operation section 19. Along with this movement, the outer end of the locking member 28, that is, the outer end of the female screw section 28a comes in contact with the stepped surface between the small-diameter inner cylindrical section 21 of the shaft operation section 19 of the operation shaft section 16 and the large-diameter outer cylindrical section 22 thereof.

Here, since the operation shaft section 16 does not slide in the axial directions, the winding core (not shown in the drawings) connected to the connection hole 18a of the shaft body section 18 does not slide either. Accordingly, the winding core is maintained in an idle state in the clock module 7. That is, even when the operation shaft section 16 is rotated by the cover section 24 of the operation head section 17 being rotated, and the winding core is rotated along with this rotation of the operation shaft section 16, the rotation of the winding core is not transmitted to the clock module 7, whereby time correction and function setting or selection such as mode switching are not performed.

In this state, the operation head section 17 is pulled toward the outside of the wristwatch case 1. Here, since the outer end of the locking member 28 in the cover section 24 is in contact with the stepped surface between the small-diameter inner cylindrical section 21 of the shaft operation section 19 of the operation shaft section 16 and the large-diameter outer cylindrical section 22 thereof, the rotation transmission member 29 of the locking mechanism 27 and the locking member 28 thereof pull the shaft operation section 19 including the spring member 25 outward by the pulling operation performed on the operation head section 17. As a result, the shaft body section 18 of the operation shaft section 16 is slid in the axial direction so as to be pulled one step further, whereby the winding core (not shown in the drawings) connected to this shaft body section 18 is pulled outward. When the winding core is pulled outward as described above, the rotation of the winding core can be transmitted to the clock module 7. In this state, when the cover section 24 of the operation head section 17 is rotated, this rotation is transmitted to the operation shaft section 16 by the first idling prevention section 23, and the shaft body section 18 of the operation shaft section 16 is rotated. Accordingly, the winding core is rotated along with the rotation of the operation shaft section 16, and this rotation is transmitted to the clock module 7. As a result, time correction and function setting or selection such as mode switching can be performed. Here, the first middle-diameter flat-surface sections 23e of the first idling prevention section 23 in the middle-diameter hole section 24b and the first buffering outer-circumferential flat-surface sections 23d of the buffering member 32 are positioned corresponding to each other and come in contact with each other, as shown in FIG. 3.

Also, here, the first operation flat-surface sections 23a of the outer cylindrical section 22 of the shaft operation section 19 are separated from the first small-diameter flat-surface sections 23b of the cover section 24, and positioned corresponding to and come in contact with the first buffering inner-circumferential flat-surface sections 23c of the buffering member 32, as shown in FIG. 3. As a result, the rotation of the cover section 24 is transmitted to the shaft body section 18 via the buffering member 32, whereby the operation shaft section 16 is rotated. By the operation shaft section 16 being rotated, the shaft body section 18 is also rotated and, along with this rotation of the shaft body section 18 of the operation shaft section 16, the winding core is rotated. Consequently, this rotation is transmitted to the timepiece module 7, whereby time correction and function setting or selection such as mode switching are performed.

As described above, the switch device 4 of this wristwatch includes the wristwatch case 1 provided with the through hole 8, the operation shaft section 16 which is inserted into the through hole 8 of the wristwatch case 1, the operation member 11 having the operation head section 17 provided on the outer end portion of the operation shaft section 16, and the buffering member 32 which is arranged in the operation head section 17 of the operation member 11. Accordingly, external impacts can be buffered by the buffering member 32. Also, the buffering member 32 includes the cylindrical main body section 33, the plurality of first projection sections 34 projecting toward the operation head section 17 side from one surface of the main body section 33, and the plurality of second projection sections 35 projecting toward the wristwatch case 1 side from the other surface of the main body section 33 located on the side opposite to the operation head section 17 side, in which the plurality of first projection sections 34 and the plurality of second projection sections 35 are arranged at positions not overlapping with each other in the axial direction of the operation member 11 when viewed from the operation head section 17 side of the operation member 11. Accordingly, external impacts exerted on the operation member 11 can be dispersed and buffered by the buffering member 32. That is, the switch device 4 of this wristwatch is structured such that, when subjected to an external impact exerted on the operation member 11, the plurality of second projection sections 35 or plurality of first projection sections 34 of the buffering member 32 disperses and buffers the impact, which includes the cylindrical main body section 33, and the plurality of first projection sections 34 and the plurality of second projection sections 35 formed on the main body section 33. This buffer member 32 can be formed without using expensive materials, which allows cost reduction.

Also, in the switch device 4 of this wristwatch, the plurality of first projection sections 34 and the plurality of second projection sections 35 are formed not to overlap with each other in the axial direction of the main body section 33. As a result, an external impact exerted on the plurality of first projection sections 34 is not directly transmitted to the wristwatch case 1, and buffered by being dispersed to the plurality of second projection sections 35 formed not to overlap with the plurality of first projection sections 34 in the axial direction. Similarly, in the switch device 4 of this wristwatch, the plurality of first projection sections 34 and the plurality of second projection sections 35 are alternately formed in the circumferential directions of the main body section 33. As a result, an external impact exerted on the plurality of first projection sections 34 is not directly transmitted to the wristwatch case 1, and buffered by being dispersed to the plurality of second projection sections 35 formed alternately with the plurality of first projection sections 34 in the circumferential directions of the main body section 33.

Moreover, the switch device 4 of this wristwatch includes the plurality of second recess sections 37 formed corresponding to the plurality of first projection sections 34 in the axial direction of the operation member 11, and the plurality of first recess sections 36 formed corresponding to the plurality of second projection sections 35 in the axial direction of the operation member 11. Accordingly, the buffering member 32 is structured such that, when an impact exerted on the operation member 11 is transmitted to the plurality of first projection section 34 or the plurality of second projection sections 35, this impact is dispersed by the plurality of second recess section 37 or the plurality of first recess sections 36 corresponding to the plurality of first projection section 34 or the plurality of second projection sections 35. As a result of this structure, the buffering member 32 functions such that impacts exerted on the operation member 11 are dispersed by the interspaces formed by the plurality of second recess section 37 or the plurality of first recess sections 36, whereby the impacts exerted on the operation member 11 are reliably and favorably buffered. More specifically, the switch device 4 of this wristwatch is structured such that, even though an impact exerted on the plurality of first projection sections 34 of the buffering member 32 is directly transmitted to the main body section 33, since the plurality of second recess sections 37 are positioned corresponding to the plurality of first projection sections 34 in the axial direction of the main body section 33, the impact exerted on the plurality of first projection sections 34 is not directly transmitted to the wristwatch case 1 and dispersed by the interspaces formed by the plurality of second recess sections 37.

Furthermore, in the case of the switch device 4 of this wristwatch, when the buffering member 32 receives an external impact in the axial direction of the operation member 11, a stress therefrom is concentrated on each boundary section 33a of the main body section 33 between each first projection section 34 and each second projection sections 35, whereby each boundary section 33a is elastically or resiliently deformed. Accordingly, even though an impact exerted on the plurality of first projection sections 34 is directly transmitted to the main body section 33, this impact exerted on the plurality of first projection sections 34 can be favorably absorbed and buffered by the elastic or resilient deformation of each boundary section 33a. That is, the switch device 4 of this wristwatch is structured such that, when the plurality of first projection sections 34 receives an external impact in the axial direction of the operation member 11, a stress therefrom is concentrated on each boundary section 33a of the main body section 33 between each first projection section 34 and each second projection sections 35, whereby each boundary section 33a is flexurally deformed, and the impact is reliably and favorably absorbed and buffered by this elastic or resilient deformation of each boundary section 33a of the main body section 33.

Still further, the switch device 4 of this wristwatch includes the cylindrical member 10 of which at least one portion is inserted into the through hole 8 of the wristwatch case 1, and into which a portion of the operation shaft section 16 of the operation member 11 is inserted. As a result of this structure, the shape of the wristwatch case 1 can be simplified even in a case where the cylindrical member 10 is formed in a complicated shape, whereby the wristwatch case 1 can be easily manufactured, which lowers the manufacturing cost of the wristwatch case 1. Yet still further, in the switch device 4 of this wristwatch, the operation shaft section 16 of the operation member 11 includes the shaft body section 18 which is inserted into the cylindrical member 10, and the shaft operation section 19 which is arranged outside the cylindrical member 10. As a result, by the shaft body section 18, the operation member 11 can be favorably attached to the cylindrical member 10 in a manner to be slidable and rotatable. In addition, by being attached to the shaft operation section 19, the operation head section 17 of the operation member 11 can be arranged outside the cylindrical member 10 and favorably operated.

Yet still further, in the switch device 4 of this wristwatch, the operation head section 17 of the operation member 11 includes at least the small-diameter hole section 24a into which the shaft operation section 19 of the operation shaft section 16 is inserted, and the middle-diameter hole section 24b into which the buffering member 32 is inserted. As a result, the shaft operation section 19 of the operation shaft section 16 can be inserted into the small-diameter hole section 24a of the operation head section 17 with the buffering member 32 being inserted into the middle-diameter hole section 24b of the operation head section 17, whereby the operation head section 17 can be favorably attached to the shaft operation section 19 in this state. Accordingly, the operation shaft section 16 can be rotated and slide in response to operations on the operation head section 17. Yet still further, in the switch device 4 of this wristwatch, the locking mechanism 27 includes the locking member 28 which is locked to the cylindrical member 10 by a rotation operation on the operation member 11, and the rotation transmission member 29 which is a separate member from the locking member 28 and rotates the locking member 28 in response to a rotation operation on the operation member 11. As a result of this structure, the rotation transmission member 29 can be rotated by a rotation operation on the operation member 11, and the locking member 28 can be rotated by the rotational movement of the rotation transmission member 29, and locked to the cylindrical member 10 by this rotational movement.

Yet still further, in the switch device 4 of this wristwatch, the rotation transmission member 29 is fitted into and fixed in the large-diameter hole section 24c in the operation head section 17 of the operation member 11 by press fitting. As a result, the rotation transmission member 29 can be unfailingly slid in response to a sliding operation on the operation head section 17 and favorably rotated in response to a sliding operation on the operation head section 17, whereby the locking member 28 can be unfailingly and favorably rotated.

Yet still further, in the switch device 4 of this wristwatch, the inner circumferential surface of the large-diameter hole section 24c is provided with the positioning restriction section 24d which restricts a position to which the rotation transmission member 29 is pressed in the operation head section 17 of the operation member 11. As a result of this structure, when the rotation transmission member 29 is being fitted into and fixed in the large-diameter hole section 24c by press fitting, a position to which the rotation transmission member 29 is pressed can be accurately and reliably restricted by the rotation transmission member 29 being pressed into the large-diameter hole section 24c and pressed against the position restriction section 24d.

Yet still further, in the switch device 4 of this wristwatch, the locking mechanism 27 includes the stopper section 31 which prevents the locking member 28 from slipping out of the operation head section 17 of the operation member 11 toward the wristwatch case 1 side. As a result, in the state where the locking of the locking member 28 with respect to the cylindrical member 10 has been released, the locking member 28 can be reliably and favorably prevented by the stopper section 31 from slipping out of the rotation transmission member 29. More specifically, in the switch device 4 of this wristwatch, the stopper section 31 includes the large-diameter flange section 31a which is formed on the outer end portion of the locking member 28 and comes in contact with the outer end surface of the rotation transmission member 29, the small-diameter stepped section 31b which is formed on the inner surface of the large-diameter flange section 31a, and the small-diameter cutout section 31c which is formed in the outer end portion of the rotation transmission member 29 and in which the small-diameter stepped section 31b is arranged. Accordingly, the large-diameter flange section 31a can be brought into contact with the outer end surface of the rotation transmission member 29, and the small-diameter stepped section 31b can be arranged in the small-diameter cutout section 31c, whereby the locking member 28 can be reliably prevented from slipping out of the rotation transmission member 29 toward the wristwatch case 1 side.

Yet still further, in the switch device 4 of this wristwatch, the buffering member 32 is arranged in the middle-diameter hole section 24b in the operation head section 17 of the operation member 11 and pressed against the locking member 28, and the locking member 28 separably comes in contact with the contact cylindrical section 13a which is a contact section formed on the cylindrical member 10, whereby the buffering member 32 arranged in the middle-diameter hole section 24b of the operation head section 17 can be reliably held between the operation head section 17 and the locking member 28. As a result, when locked to the cylindrical member 10, the locking member 28 comes in contact with the contact cylindrical section 13a of the cylindrical member 10, and is unfailingly and favorably pressed against the outer surface of the wristwatch case 1.

Yet still further, the switch device 4 of this wristwatch includes the spring member 25 which forces the operation head section 17 of the operation member 11 in the direction to be pressed outside the wristwatch case 1. As a result, when the locking of the locking member 28 with respect to the cylindrical member 10 is released, the operation head section 17 of the operation member 11 can be unfailingly and favorably pressed outside the wristwatch case 1 by the spring force of the spring member 25 without the operation shaft section 16 of the operation member 11 being moved.

In the above-described embodiment, the locking mechanism 27 has a screw locking structure in which the operation head section 17 is locked to the large-diameter cylindrical section 13 by the male screw section 13a being screwed into the female screw section 28a. However, the present disclosure is not limited thereto, and the locking mechanism 27 may have a simplified locking structure in which an engaging projection is provided on the locking member 28, and an engaging groove which engages with the engaging projection is formed in the large-diameter cylindrical section 13. More specifically, in the simplified locking mechanism, the operation head section 17 is pressed toward the wristwatch case 1 side, the engaging projection of the locking member 28 is inserted into the engaging groove through the opening of the engaging groove of the large-diameter cylindrical section 13, the operation head section 17 is rotated in this state by a predetermined angle (such as 90 degrees), and the engaging projection of the locking member 28 is rotated by a predetermined angle in the locking groove of the large-diameter cylindrical section 13 and separated from the opening, whereby the engaging projection of the locking member 28 engages with the engaging groove of the large-diameter cylindrical section 13.

Also, in the above-described embodiment, the first idling prevention section 23 includes the first operation flat-surface sections 23a formed on the outer circumferential surface of the outer cylindrical section 22 of the shaft operation section 19 of the operation shaft section 16, the first small-diameter flat-surface sections 23b formed on the inner circumferential surface of the small-diameter hole section 24a of the cover section 24 corresponding thereto, the first buffering inner-circumferential flat-surface sections 23c formed on the inner circumferential surface of the buffering member 32, the first buffering outer- circumferential flat-surface sections 23d formed on the outer circumferential surface of the buffering member 32, and the first middle-diameter flat-surface sections 23e formed on the inner circumferential surface of the middle-diameter hole section 24b of the cover section 24. However, the present disclosure is not limited thereto and a structure may be adopted in which, for example, the first operation flat-surface sections 23a formed on the outer circumferential surface of the outer cylindrical section 22 of the shaft operation section 19 of the operation shaft section 16, the first small-diameter flat-surface sections 23b formed on the inner circumferential surface of the small-diameter hole section 24a of the cover section 24 corresponding thereto, the first buffering inner-circumferential flat-surface sections 23c formed on the inner circumferential surface of the buffering member 32, the first buffering outer-circumferential flat-surface sections 23d formed on the outer circumferential surface of the buffering member 32, and the first middle-diameter flat-surface sections 23e formed on the inner circumferential surface of the middle-diameter hole section 24b of the cover section 24 have a non-circular shape such as a polygonal shape including a quadrilateral shape and a pentagonal shape, or an elliptical shape.

Moreover, in the above-described embodiment, the second idling prevention section 30 includes the second locking flat-surface sections 30a formed on the outer circumferential surface of the locking member 28 and the second transmission flat-surface sections 30b formed on the inner circumferential surface of the rotation transmission member 29 corresponding thereto. However, the present disclosure is not limited thereto and a structure may be adopted in which the outer circumferential surface of the locking member 28 and the inner circumferential surface of the rotation transmission member 29 corresponding thereto have a non-circular shape such as a polygonal shape including a quadrilateral shape and a pentagonal shape, or an elliptical shape. Furthermore, in the above-described embodiment, the cylindrical member 10 is attached to the through hole 8 formed in the case main body 1a of the wristwatch case 1, and the operation member 11 is attached to this cylindrical member 10. However, the present disclosure is not limited thereto. For example, a structure may be adopted in which the large-diameter cylindrical section 13 of the cylindrical member 10 is integrally formed with the case main body 1a. Still further, in the above-described embodiment, the switch device 4 has the structure where the winding core (not shown in the drawings) in the clock module 7 is pulled one step further. However, the present disclosure is not limited thereto. For example, the switch device 4 may have a structure in which the winding core (not shown in the drawings) in the clock module 7 can be pulled further in multiple steps such two or more steps.

Yet still further, in the above-described embodiment, the present disclosure has been applied in the switch device 4 on the three o’clock side. However, the present disclosure is not limited thereto, and may be applied in the push-button switch 3 on the two o’clock side, the four o’clock side, the eight o’clock side, or the ten o’clock side. Yet still further, in the above-described embodiment, the switch device 4 having the locking mechanism 27 has been described. However, the present disclosure is not necessarily required to be applied in a switch device having a lock mechanism. Yet still further, in the above-described embodiment, the present disclosure has been applied in a wristwatch. However, the present disclosure is not necessarily required to be applied in a wristwatch, and may be applied in various types of timepieces such as a travel watch, an alarm clock, a table clock, and a wall clock. In addition, the present disclosure is not necessarily required to be applied in timepieces, and may be applied in electronic devices such as portable information terminals.

While the present disclosure has been described with reference to the preferred embodiments, it is intended that the disclosure be not limited by any of the details of the description therein but includes all the embodiments which fall within the scope of the appended claims.

What is claimed is:

1. A switch device comprising:
a case provided with a through hole;
an operation member having a shaft section which is inserted into the through hole of the case and a head section provided on an outer end portion of the shaft section; and
a buffering member which is arranged in the head section of the operation member,
wherein the buffering member includes a cylindrical main body section, a plurality of first projection sections which projects toward the head section side from one surface of the main body section, and a plurality of second projection sections which projects toward the case side from an other surface of the main body section located on a side opposite to the head section side, and
wherein the plurality of first projection sections and the plurality of second projection sections are arranged at positions not overlapping with each other in an axial direction of the operation member when viewed from the head section side of the operation member.

2. The switch device according to claim 1, wherein the buffering member includes a plurality of second recess sections provided corresponding to the plurality of first projection sections in the axial direction of the operation member, and a plurality of first recess sections provided corresponding to the plurality of second projection sections 35 in the axial direction of the operation member.

3. The switch device according to claim 2, wherein each boundary section of the main body section between each first projection section and each second projection section is elastically or resiliently deformed when an external impact in the axial direction of the operation member is exerted on the buffering member.

4. The switch device according to claim 1, further comprising:
a cylindrical member of which at least one portion is inserted into the through hole of the case, and into which a portion of the shaft section of the operation member is inserted,
wherein the shaft section of the operation member includes a shaft body section which is inserted into the cylindrical member, and a shaft operation section which is arranged outside the cylindrical member, and
wherein the head section of the operation member includes a small-diameter hole section into which the shaft operation section of the shaft section is inserted, and a middle-diameter hole section into which the buffering member is inserted.

5. The switch device according to claim 4, further comprising:
a locking mechanism which locks the operation member to the cylindrical member.

6. The switch device according to claim 5, wherein the locking mechanism includes a locking member which is locked to the cylindrical member by a rotation operation on the operation member, and a rotation transmission member which is a separate member from the locking member and rotates the locking member in response to the rotation operation on the operation member.

7. The switch device according to claim 6, wherein the rotation transmission member is fitted into and fixed in a large-diameter hole section in the head section of the operation member by press fitting.

8. The switch device according to claim 7, wherein an inner circumferential surface of the large-diameter hole section is provided with a positioning restriction section which restricts a position to which the rotation transmission member is pressed in the head section of the operation member.

9. The switch device according to claim 6, wherein the locking mechanism includes a stopper section which prevents the locking member from slipping out of the head section of the operation member toward the case side.

10. The switch device according to claim 6, wherein the buffering member is arranged in the middle-diameter hole section in the head section of the operation member and pressed against the locking member, and
wherein the locking member separably comes in contact with a contact section provided on the cylindrical member.

11. The switch device according to claim 1, further comprising:
an energizing member which forces the head section of the operation member in a direction to be pressed outside the case.

12. A timepiece comprising the switch device according to claim 1.
